(19) United States
(12) Patent Application Publication
(10) Pub. No.: US 2006/0100894 A1
(43) Pub. Date: May 11, 2006

(54) Method and system for generating qualified sales leads for off-site third party vendors

(75) Inventors: Howard A. Weiner, Wayne, NJ (US); Dorian Lindsay, Peekskill, NY (US); Keen Yee, Millwood, NY (US)

Correspondence Address: DARBY & DARBY P.C., P. O. BOX 5257, NEW YORK, NY, 10150-5257, US

(73) Assignee: Focas, LLC, Wayne, NJ (US)

(21) Appl. No.: 11/255,369

(22) Filed: Oct. 20, 2005

Related U.S. Application Data
(60) Provisional application No. 60/625,387, filed on Nov. 5, 2004.

(51) Int. Cl. G06Q 99/00

(52) U.S. Cl. 705/1

(57) ABSTRACT

Generation of qualified sales leads and market research data comprises use of an interactive device at a first commercial location by a customer of a particular vendor. Customer information is input into the interactive device and that information can be—but need not be—related with a pre-existing record of information about the customer maintained by the particular vendor. The customer interacts with the device to be presented with information about goods or services of another vendor or to permit capture of market research data. The customer receives a coupon that is immediately redeemable for value against goods or services at the particular vendor for having so-interacted with the device. Additional methods that generate such leads and data are also described.

This application claims priority under 35 U.S.C. § 119(e) from U.S. Provisional Application Ser. No. 60/625,387, filed Nov. 5, 2004, entitled “Method and System for Generating Qualified Sales Leads for Off-Site Third Party Vendors,” the disclosure of which is hereby incorporated by reference as if set forth in its entirety herein.

### FIELD OF THE INVENTION

The present invention concerns securing sales leads and/or performing interactive consumer market research for a given vendor. More particularly, the present invention relates to a system and method that efficiently (1) collects the identification and contact information for individuals interested in receiving additional information from a given vendor about goods and services offered by the vendor, and/or (2) collects consumer responses to goods and services offered by such vendor.

### BACKGROUND OF THE INVENTION

Known systems and methods exist for identifying individual consumers to whom specific goods and services ought be marketed. The profitability and viability of a commercial enterprise often rides and falls with its ability to effectively and efficiently market its wares to consumers. Targeting advertising directly to only those individuals who are likely customers and are interesting in learning about the goods and services is an effective means of marketing in most consumer industries. However, identifying the specific consumers who are open to learning about a vendor's goods and services can prove difficult and expensive. Accordingly, vendors often turn to less targeted forms of advertising in order to reach an unidentified target. Mass mailings and broadcast commercial advertising, which are popular forms of general advertising and effective for many purposes, require the advertiser to pay for distribution of advertising to all inhabitants in a market, rather than focusing the advertising on the most likely purchasers of the advertiser's goods and services. Mass marketing techniques such as SPAM email and cold calling may be deemed intrusive and may irritate consumers, leading to a feeling of ill will towards the responsible vendor because the targets of uninvited mass marketing may not want to be contacted by the vendor.

What is desired, therefore, is a system and method for permitting consumers who desire to be contacted by a particular vendor to identify themselves to the vendor, for providing that vendor with contact information for that consumer so that the vendor can directly market its wares to the interested consumer, for permitting consumers to provide the vendor with opinions and approval of the vendor's products and services, or a combination of the foregoing.

### SUMMARY OF THE INVENTION

In accordance with one aspect of the invention, a method provides to a first vendor contact information concerning the customer of another (second) vendor including which goods or services might be of interest to that customer. The method is performed at a commercial location that provides goods or services of the second vendor which location is geographically distinct from that of the first vendor. The method includes inputting to a programmed machine information that identifies the potential customer of the first vendor, relating the input customer-identifying information with a pre-existing record of information about the potential customer maintained by the second vendor, permitting the potential customer to select at the programmed machine one or more vendors including the first vendor, receiving at the programmed machine the selection made by the potential customer, presenting the information about one or more goods or services offered by the first vendor to the customer at the programmed machine, obtaining a permission of the potential customer to be contacted by the first vendor, and, in the event that the permission is obtained, providing the potential customer with a coupon that is immediately redeemable for value against goods or services.

In accordance with another aspect of the invention, an automated method for handling a qualified sales lead is provided. This method comprises the steps of obtaining identification data that identifies a person, receiving selection data from the person identifying a vendor from whom information about goods and services is desired, relating the identification data with customer data about the person, the customer data being located in a pre-existing database, communicating the customer data to the vendor as the qualified sales lead, and responding to the person with information concerning goods or services offered by the vendor.

In accordance with yet another aspect of the invention, an automated method for handling a qualified sales lead includes the steps of obtaining contact data that identifies a person located within a first commercial outlet and at least one mode for contacting the person, receiving selection data from the person identifying a vendor at a location other than the first commercial outlet from whom information about goods and services is desired, transmitting the contact data to the vendor as the qualified sales lead, and responding to the person via the at least one mode for contacting the person with information concerning goods or services offered by the vendor.

In still a further aspect, the present invention can provide a method for encouraging a visit to one or more prescribed commercial outlets, comprising the steps of providing a data entry terminal accessible by a potential customer of the one or more prescribed commercial outlets, permitting the potential customer to select at the data entry terminal a commercial outlet from among the one or more commercial outlets, receiving at the data entry terminal a selection made by the potential customer, presenting information to the potential customer concerning goods or services offered by the selected commercial outlet, including within the presented information a discount offer and an interactive customer-ID submit control, in the event that the potential customer interacts with the customer-ID submit control, electronically transmitting to the selected commercial outlet an indication of customer-ID, and in the event that the potential customer presents the indication of customer-ID at the selected commercial outlet, providing the potential customer with the offered discount.

The invention also has utility in providing the first vendor with market research data. Thus, in yet still a further aspect of the invention, a method for collecting market research data from a customer is performed at a commercial location that provides goods or services of a vendor and comprises the steps of inputting to a programmed machine information that identifies the customer of the vendor, relating the input customer-identifying information with a pre-existing record of information about the customer maintained by the vendor, presenting to the customer through the programmed machine a third-party presentation, capturing responses of the customer concerning the presentation through the programmed machine, providing the customer with a coupon that is immediately redeemable for value against goods or services at the vendor, and providing at least a portion of the information related to the input customer-identification information and the captured responses to the third party.

These and other aspects, features and advantages of the present invention can be more fully understood from the accompanying drawings and description of certain embodiments thereof.

### BRIEF DESCRIPTION OF THE DRAWINGS

FIG. 1 illustrates a flow diagram of an exemplary process in accordance with the present invention;

FIG. 1A illustrates an optional, additional or alternative process flow useful in collecting market research data.

FIG. 2 illustrates an exemplary opening screen presented on the display of an embodiment of the present invention;

FIG. 3 illustrates an identification entry screen presented on the display of an embodiment of the present invention;

FIG. 4 illustrates a vendor selection screen presented on the display of an embodiment of the present invention;

FIG. 5 illustrates a vendor information screen that is selectable by the customer from among the vendors on the vendor selection screen of FIG. 4, shown presented on the display of an embodiment of the present invention;

FIG. 6 illustrates a product information and more detailed product selection screen for the vendor of FIG. 5, shown presented on the display of an embodiment of the present invention;

FIG. 7 illustrates a coupon produced by an exemplary kiosk embodiment of the present invention; and

FIG. 8 illustrates a screen shot of a concluding message presented on the display of an embodiment of the present invention.

### A DETAILED DESCRIPTION OF CERTAIN EMBODIMENTS OF THE PRESENT INVENTION

A detailed description of certain embodiments of the present invention will now be presented with reference to the above-noted figures.

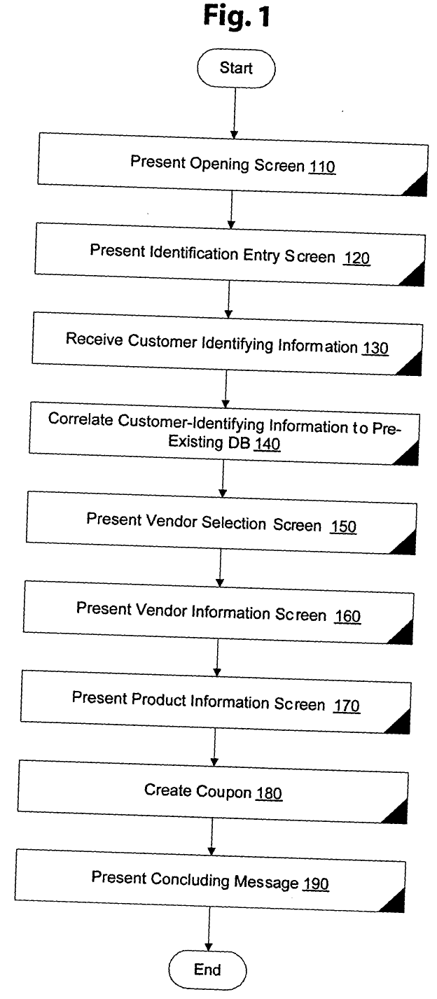

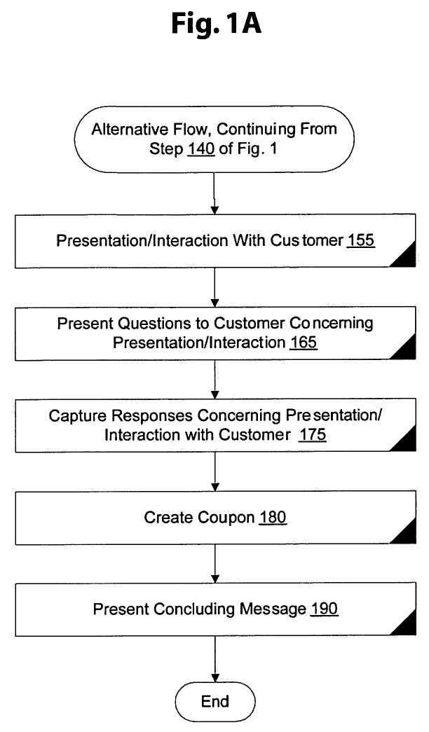

The flow chart of FIG. 1 illustrates an interactive process being executed on a kiosk or other interactive device (e.g., handheld device/tablet computer) operated by a consumer located at a commercial establishment. In the embodiment described herein, the commercial establishment is an automotive garage specializing in performing automobile oil and filter changes (hereafter, “a lube shop”), among other services. In the present embodiment the interactive device is located in the customer waiting room of the lube shop and is preferably decorated in a manner that is visually and audibly attractive to patrons waiting for the completion of service on their respective cars. Alternatively, the process may be executed on a wireless device by a consumer either in his vehicle or elsewhere in and around the lube shop.

The construction and operation of an interactive device in accordance with the described embodiment is explained in connection with a kiosk, though the invention can be used with a variety of devices including wireless devices. As used herein, the term “kiosk” is to be understood as an interactive device, whether portable and wireless or stationary, such as a conventional kiosk. At its most basic level, the interactive device can be the same as that of interactive kiosks typically located in shopping malls and other commercial outlets. The kiosk includes a microprocessor-based personal or server-based computer operating on known operating system software, such as Microsoft Windows XP or LINUX, and housed within the kiosk out of the view of customers. The kiosk includes a touch screen display monitor connected to an output of the computer, thus eliminating the need for a separate keyboard. Notwithstanding the foregoing, a keyboard can be included and positioned for access by the patrons.

The specific interactive process illustrated in FIG. 1 is preferably being electronically executed on the kiosk. That process is defined and created using a database programming application known as The Databaser, however, any commercially known database programming language or application may be utilized to create and implement the functionality and visual and audio displays of the interactive kiosk program described herein. Any person skilled in the art of computer and database software programming can implement the described process.

As mentioned above, a wireless handheld device is optionally substituted for a kiosk, thus allowing a customer waiting for completion of service in the lube shop to participate in the interactive process from a location other than standing in front of the kiosk. For example, using a wireless handheld device the customer can interact with the process of FIG. 1 while seated inside his vehicle while his vehicle is serviced. Just as with the kiosk, the handheld device preferably is a programmable microprocessor device, such as a Tablet PC or similarly sized device, which runs known operating system software and utilizes known database applications and programs to implement the interactive process. Other portable interactive devices that are capable of executing program flows such as described in connection with FIG. 1 and elsewhere herein can also be used.

In accordance with the present embodiment, a captive audience member, such as an individual waiting for the completion of an oil change, approaches the kiosk. The individual executes the interactive process on the kiosk screen as described by the flow chart of FIG. 1. Preferably, the kiosk defaults to an attract mode between sessions with individuals, presenting images and sounds that highlight its offerings and attract patrons to initiate a session. The process of FIG. 1 is preferably capable of being performed within a time range limited by the amount of time required for the oil change to take place, typically 15 minutes, although the process may be completed in substantially less time.

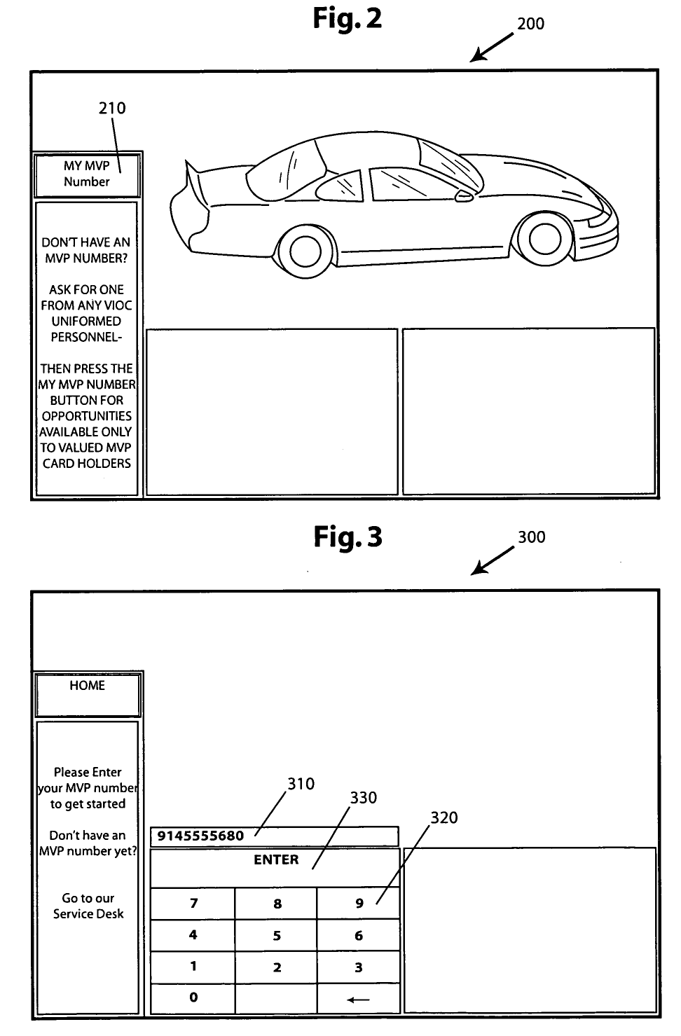

With continued reference to the flow chart of FIG. 1, at step 110, the kiosk presents an opening screen to the customer. FIG. 2 illustrates an exemplary opening screen 200. Opening screen 200 preferably displays colorful graphics and other features attractive to the senses of the customer in order to attract and hold the customer's attention.

Opening screen 200 explains, optionally through rolling text and a voiceover, the opportunity available to the customer and invites the customer to begin the process by pushing a customer identification button 210. Upon pressing the customer identification button 210, the process illustrated in FIG. 1 advances to step 120. At step 120, the kiosk presents an identification entry screen to the customer and invites the customer to enter unique data identifying the customer. FIG. 3 illustrates an exemplary identification entry screen 300.

The customer then may elect to enter customer identifying information in box 310 of identification entry screen 300 utilizing touchscreen keypad 320. The use of a touchscreen keypad is preferred as it can be dynamically configured to suit the input needs of a given data entry screen, and minimizes both parts and potential for vandalism. The customer identifying information is any one of various modes of identifying the customer. Examples of such customer identifying information include VIN number, telephone number, license plate number or any combination of these with other forms of identification, such as the customer's name. In the present exemplary embodiment, the user enters an identification number provided by the lube shop and referred to as the “MVP number” (see customer identification button 210 of FIG. 2).

The user presses the Enter button 330 once the customer identifying information has been entered using the keypad. At step 130 of the process of FIG. 1, the kiosk receives the customer identifying information.

With continued reference to the process of FIG. 1, the interactive process advances to step 140. At step 140, the process of a preferred embodiment of the invention includes the relating of customer identifying information to a record in a pre-existing database for that customer. In the present exemplary embodiment of the kiosk located in a lube shop, the pre-existing database of information contains information collected by the lube shop about the customer in the ordinary course of the lube shop's business, such as home address and telephone number contact information, as well as information relating to the type of vehicle driven by the customer and at least some information concerning the service history of the car. The pre-existing database of information is located remotely from the kiosk and connected to the computer of the kiosk via a local area network connection (wired or wireless), if located within the same commercial establishment as the kiosk or, alternately, is located via long-haul telecommunications circuits if the pre-existing database is located off-site. Alternatively, a copy of the pre-existing database resides on the computer located in the kiosk and the kiosk can be apprised of updates to the pre-existing database at intervals.

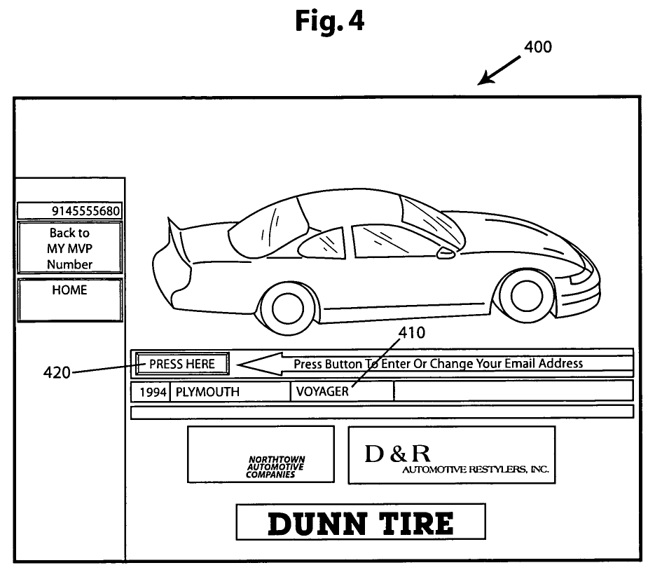

Once the record in the pre-existing database corresponding to the present customer is located, the process of FIG. 1 advances to step 150 and the kiosk displays a vendor selection screen to the customer with the name and logo of each participating vendor. FIG. 4 illustrates a vendor selection screen 400. Vendor selection screen 400 includes the identification of vendors from which the customer at the kiosk can seek additional information. The customer selects the vendor of choice by pressing the area of the touch screen display corresponding to the desired vendor.

In the presently preferred embodiment, the vendors presented to the customer in vendor display screen 400 optionally are selected for display based on the record of information about the customer retrieved from the pre-existing database in step 140. Thus, as an example, a record revealing that the customer drives an expensive Lexus will cause the kiosk to only display vendors that offer high-end goods and services or will present such vendors at the top of a list or a more prominent position on the display screen. Additionally, the vendors presented on vendor display screen 400 is optionally changed by the kiosk operators on some predetermined basis in order to keep the selection of vendors new and interesting to the customers, who periodically return for service at the lube shop. Preferably, the vendors and the content and arrangement of their information and product screens within any given kiosk can be updated and reconfigured remotely by the kiosk operator.

Of course, the vendor selection display need not be based on the contents of the pre-existing database, and the display can be defined in other ways, such as a setting which defines a set of vendors to be displayed at the kiosk at any given time.

It should be understood that in connection with certain interactive sessions, such as those with patrons who are new customers and for whom the kiosk has no record, the process of FIG. 1 can proceed without reference to the pre-existing database. In those sessions, the vendor selection display in FIG. 4 is made without regard to the pre-existing database, information gathered at the kiosk is preferably coordinated with the customer information from the pre-existing database prior to forwarding to the vendor. Alternatively, information gathered at the kiosk is forwarded to the vendor without being coordinated with any information from the pre-existing database.

As further illustrated in FIG. 4, vendor selection screen 400 optionally presents the customer with information retrieved from the customer's record in the pre-existing database. Thus, vendor selection screen 400 includes, at 410, the identification of the customer's car, which in this case is a 1994 Plymouth Voyager.

Vendor selection screen 400 further preferably includes email entry button 420. Use of this button allows the customer to enter an email address by which the customer is subsequently contacted by one or more of the vendors presented on vendor selection screen 400. Such a process may be necessary in instances where the pre-existing database of customer information fails to include the customer's email address as a form of customer contact. Use of email entry button 420 by the customer is preferably optional.

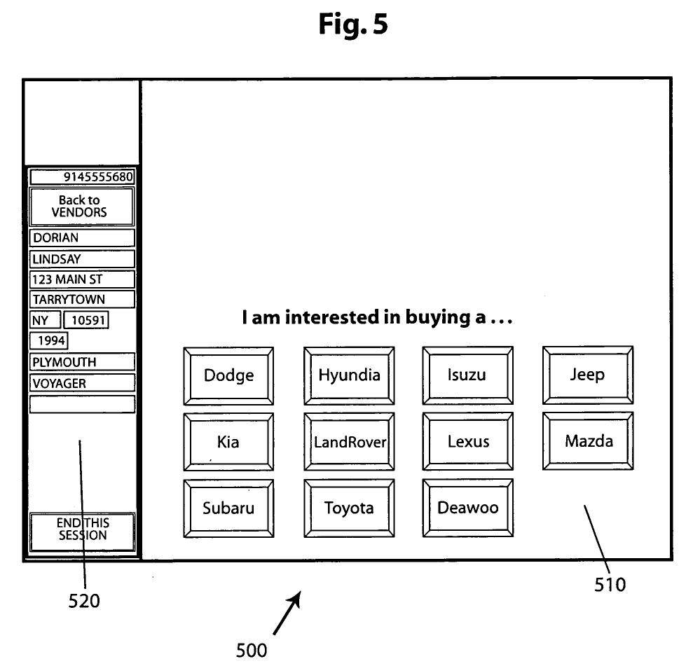

Upon selection by the customer of one of the vendors presented on vendor selection screen 400, the process of FIG. 1 advances to step 160 and the kiosk presents the customer with a vendor information screen. FIG. 5 illustrates an exemplary vendor information screen 500. Vendor information screen 500 presents the customer with information about the vendor selected by the customer at vendor selection screen 400 and preferably further includes options that allow a customer to retrieve additional information about the vendor and the vendor's goods and services. The exemplary vendor selection screen 500 illustrated in FIG. 5 presents information about a car dealership. Here, the customer selects one of multiple first level vendor product selection buttons 510 to secure information about specific makes of cars for each listed car manufacturer.

Vendor information screen 500, like vendor selection screen 400, optionally presents its choices to the customer based on the knowledge of the customer secured through the pre-existing database. Thus, as an example, if the record of the customer in the pre-existing database reveals that the customer is presently driving a Toyota Corolla, the system rearranges the order of first level vendor product selection buttons 510 for the listed car manufacturers so that Toyota is listed first or in a prominent position among the manufacturers.

As shown in FIG. 5, vendor information screen 500 optionally presents the customer with information about the customer that is retrieved from the pre-existing database, as shown in window pane 520, when such information is available to the kiosk.

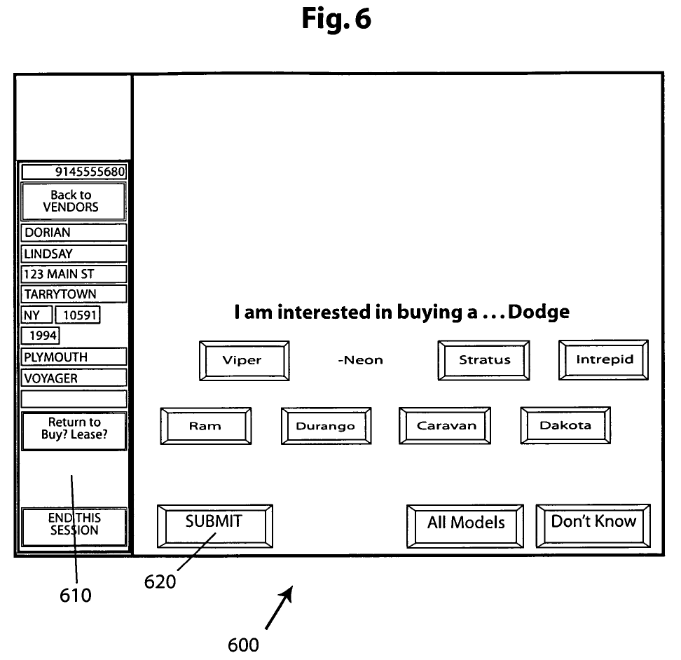

Once the customer selects one of the first level vendor product selection buttons 510 in vendor information screen 500, the process of FIG. 1 advances to step 170 and the kiosk presents the customer with a product information screen. FIG. 6 illustrates an exemplary product information screen 600. Product information screen 600 presents the customer with further details concerning a particular good or service in which the customer has indicated an interest. In product information screen 600 of FIG. 6, the customer optionally has the ability to choose from among various models of Dodge cars and trucks as a result of having selected the vendor product selection buttons 510 for Dodge via the vendor information screen 500.

As shown in FIG. 6, product information screen 600 optionally presents the customer with information about the customer retrieved from the pre-existing database, as shown in window pane 610.

When the customer has selected one or more goods or services for which the customer desires to learn more information utilizing product information screen 600, the customer selects the submit button 620. By pressing the submit button, the customer consents to be contacted by the selected vendor in order to secure additional information, including pricing information, about goods and services offered by the vendor. In other words, the customer “opts-in” to that vendor's marketing contact list.

The process of FIG. 1 then advances to step 180 at which point the kiosk, to reward the customer for completing the interactive process, generates a coupon that the customer uses to secure a discount at the store or business at which the customer is presently located, i.e., at the lube shop. FIG. 7 illustrates an exemplary coupon for use in securing a discount on the oil change for which the customer is waiting. The coupon is preferably displayed on the touch screen display of the kiosk and is also printed, either by a printer in the kiosk or remotely located at the point of sale of the lube shop, or otherwise communicated to the point of sale device (e.g., by wired or wireless transmission for association with the customer identification entered using button 210) at the lube shop. As shown in the exemplary coupon of FIG. 7, the coupon optionally includes the name of the customer 720 (“Dorian Lindsay”) and the make, model and year of the customer's car 720 in order to avoid fraud or misuse of the discount.

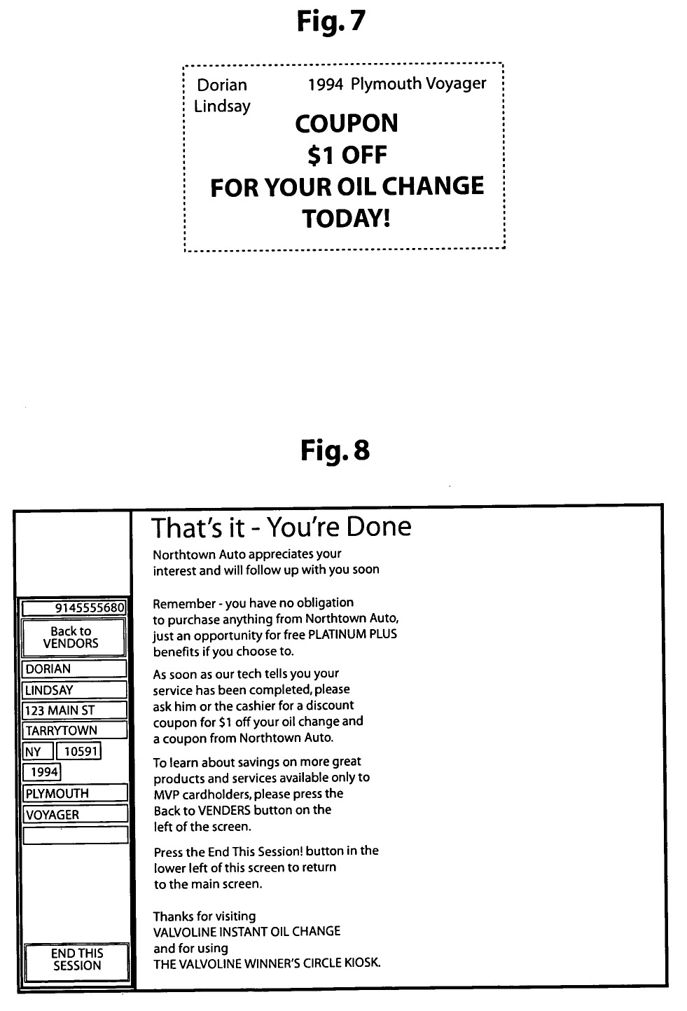

The process of FIG. 1 then concludes or includes a final step 190 in which the kiosk touch screen display presents a concluding message screen to the customer expressing thanks to the customer for using the kiosk and providing further instructions to the customer concerning coupon redemption and related matters. FIG. 8 illustrates a concluding message screen that can be presented to the customer. Thereafter, the kiosk preferably returns to the attract mode, as previously described.

Referring now to the FIG. 1A, an optional, additional or alternative process flow is described. The vendor selection screen can be configured to permit the customer to be awarded a coupon in response to other interaction with the interactive device. By way of example, instead of following vendor selections from the vendor selection screen 500, the customer can be prompted to complete a questionnaire of a third party which results in the collection of market research data and the award of the coupon to the customer. The questionnaire can be presented directly to the customer at step 155, or the customer can be presented with other content to review, which is optionally followed by questions posed to the customer at step 165. The presentation at step 155 can be interactive, such as a videogame or a series of pages that the customer is shown and from which the customer must make selections, or it can comprise a display at the interactive device. A series of questions can be presented to the customer (e.g., a survey) at step 165 after the presentation and the results collected as market research data. Also, any interactions and responses to the presentation by the customer can be captured to comprise the market research data based on actions or selections made by the customer during the course of the presentation, without the use of formal questions, at step 175. Alternatively, the market research data can be collected as a result of both interactions and formal questions posed to the customer. Once the presentation or interaction with the customer is complete, a coupon is created at step 180 and a concluding message is presented at step 190, as previously described. The third party is provided with the captured responses, and is preferably also provided with at least a portion of the information related to the input customer-identification information (i.e., a portion of the information from the pre-existing database).

The processes described above are repeated for each customer utilizing the kiosk. A record of all of the customers' respective interactions with the kiosk, including the vendors and products identified by the customers and/or any market research data that has been collected, is maintained, preferably by the kiosk computer but instead or additionally can be maintained by a remote server, such as one maintained by the kiosk operator. At a predetermined point in time, the record of this activity is manipulated and preferably compiled such that a list is created for each vendor identifying: 1) customers who have expressed an interest in the vendor's products; 2) contact information for the customer; 3) the identification of particular goods or services that interest the customer; 4) market research responses; or 5) a combination of the foregoing. The contact information for the customer includes contact information secured from the record for the customer from the pre-existing database or the e-mail address provided by the customer using vendor selection screen 400. The list of information, or a record from each individual session if that is desired, is then distributed to the respective vendors as vendor qualified sales leads lists and/or market research responses. This distribution is by a direct download from the kiosk or based on a transfer of data from the kiosk to a server of the kiosk operator or the lube shop proprietor.

One skilled in the art of database manipulation will appreciate that the creation of the vendor qualified sales leads lists and/or market research responses optionally occurs offsite from the kiosk computer following a download of the information stored on the kiosk computer to a different computer. Also, one skilled in the art will appreciate that the database applications utilized and programming methods employed to create the vendor qualified sales leads and/or market research responses is not salient to the present invention.

An advantageous business model is optionally applied to the utilization of the kiosk described herein to enhance its use and efficacy. Vendors are optionally charged a prescribed fee by the kiosk owner for each qualified sales lead or market research response provided to the vendor. This fee is optionally utilized by the kiosk owner to subsidize the coupon discount provided to the customer of the proprietorship in which the kiosk is located. The fee is also optionally utilized, in part, as payment to the proprietorship, i.e., the lube shop, for the right to maintain the kiosk in the lube shop. Other business models are optionally applied with the idea that a vendor will be willing to pay a certain and significant fee for consumer responses and/or qualified sales leads of individuals who indicate a willingness and desire to be contacted by a vendor. Moreover, the willingness of an individual to be contacted by a vendor is advantageously increased if the customer is informed in advance that his interactive participation with the kiosk and eventual information request to a vendor will result in a monetary benefit in the form of an immediately redeemable coupon for the service, i.e., the oil change, for which the customer is presently waiting.

Many variations of the above-described embodiments fall within the scope of the present invention.

For example, in addition to providing the customer with an immediately redeemable coupon for goods and services being provided at the commercial location in which the kiosk is located, the kiosk or point of sale location optionally provides a coupon for goods and services of the vendor in which the customer has expressed interest. This coupon provides an additional incentive for the customer to later seek out the vendor and reinforces the quality of the sales lead, and would be redeemable at a location that is distinct and remote from that of the location at which the kiosk itself is located.

The additional coupon is optionally customized in accordance with the information about the customer provided by the record for the customer in the pre-existing database or in accordance with the information provided by the customer at vendor information screen 500, product information screen 600, or some other screen.

The process of FIG. 1 is optionally modified to permit a customer to select a preferred mode of contact. Thus, the customer specifies the manner in which a selected vendor may or may not contact the customer to provide additional information to the customer about the vendor's goods and services. For example, the customer optionally specifies that he prefers to be contacted by email, but does not wish to be contacted by telephone. The coupon presented to the customer for a discount for service at the lube shop and the fee paid by the vendor to the kiosk owner optionally varies depending on the mode of contact selected by the customer. In this manner, a customer who permits contact by phone will receive a greater discount. In turn, because telephone contact may be a more effective sales method, the vendor is optionally charged a greater fee by the kiosk owner for such a sales lead.

The process described by FIG. 1 is optionally modified to allow a customer to repeat the process for multiple vendors. Accordingly, a customer views information concerning goods and services offered by multiple vendors and asks to be contacted by some or all of these vendors. In this manner, the customer secure multiple coupons for use for service at the lube shop and the kiosk owner generates revenue from each vendor selected by the customer.

While the invention has been described in connection with certain embodiments thereof, the invention is capable of being practiced in other forms and using other machines and routines. Accordingly, the invention is defined by the recitations in the claims appended hereto and equivalents thereof.

We claim:

1. A method for providing contact information to a first vendor concerning a potential customer desirous of receiving information about one or more goods or services offered by the first vendor, the method being performed at a commercial location that provides goods or services of a second vendor, the second vendor being geographically distinct from the first vendor, the method comprising the steps of:
inputting to a programmed machine information that identifies the potential customer of the first vendor;
relating the input customer-identifying information with a pre-existing record of information about the potential customer maintained by the second vendor;
permitting the potential customer to select at the programmed machine one or more vendors including the first vendor;
receiving at the programmed machine the selection made by the potential customer;
presenting the information about one or more goods or services offered by the first vendor to the customer at the programmed machine;
obtaining a permission of the potential customer to be contacted by the first vendor; and,
in the event that the permission is obtained, providing the potential customer with a coupon that is immediately redeemable for value against goods or services.

2. The method of claim 1, including the additional step of transmitting the pre-existing record of information about the potential customer to the first vendor.

3. The method of claim 1, wherein the potential customer of the first vendor is an actual customer of the second vendor and wherein the permitting, receiving, presenting, obtaining and providing steps are performed while the actual customer waits to complete a purchase transaction at the commercial location of the second vendor.

4. The method of claim 1, wherein contact is by one a prescribed modality.

5. The method of claim 1, wherein the potential customer enters into or selects at the programmed machine at least one modality for contact.

6. The method of claim 1, including the step of printing a coupon redeemable with each of the first vendor and second vendor.

7. The method of claim 1, wherein the steps of claim 1 are repeated for each of multiple customers.

8. The method of claim 1, wherein the steps of claim 1 are repeated by one customer for multiple vendors other than the first vendor among the one or more vendors.

9. The method of claim 1, wherein the providing step is performed at a location geographically different than the commercial location of the second vendor.

10. The method of claim 1, wherein the providing step is performed at the commercial location of the second vendor.

11. An automated method for handling a qualified sales lead, comprising the steps of:
obtaining identification data that identifies a person;
receiving selection data from the person identifying a vendor from whom information about goods and services is desired;
relating the identification data with customer data about the person, the customer data being located in a pre-existing database;
communicating the customer data to the vendor as the qualified sales lead; and
responding to the person with information concerning goods or services offered by the vendor.

12. The method of claim 11, including the additional steps of permitting the person to enter preference data concerning the goods or services offered by the vendor, and utilizing the preference data to respond to the person with customized information concerning certain goods or services of the vendor.

13. The method of claim 11, wherein the responding step responds to the person using a person-selected mode of communication.

14. The method of claim 11, including the steps of securing contact information for the person and utilizing the contact information to provide the person with information about the goods and services offered by the vendor.

15. The method of claim 11, wherein the obtaining and receiving steps are performed utilizing a kiosk located on the premises of a commercial establishment other than that of the vendor, including the further step of providing the person with a coupon for goods or services for use at the commercial establishment.

16. An automated method for handling a qualified sales lead, comprising the steps of:
obtaining contact data that identifies a person located within a first commercial outlet and at least one mode for contacting the person;
receiving selection data from the person identifying a vendor at a location other than the first commercial outlet from whom information about goods and services is desired;
transmitting the contact data to the vendor as the qualified sales lead; and
responding to the person via the at least one mode for contacting the person with information concerning goods or services offered by the vendor.

17. The method of claim 16, wherein the contact data is secured from a record for the person located in a pre-existing database compiled by the first commercial outlet.

18. The method of claim 16, wherein the obtaining and receiving steps are performed at a kiosk and the contact data is secured directly from the person through use of an entry device for the kiosk.

19. The method of claim 16, wherein the kiosk is located geographically distinct from, but within the vicinity of multiple commercial outlets.

20. A method for encouraging a visit to one or more prescribed commercial outlets; comprising the steps of:
providing a data entry terminal accessible by a potential customer of the one or more prescribed commercial outlets;
permitting the potential customer to select at the data entry terminal a commercial outlet from among the one or more commercial outlets;
receiving at the data entry terminal a selection made by the potential customer;
presenting information to the potential customer concerning goods or services offered by the selected commercial outlet;
including within the presented information a discount offer and an interactive customer-ID submit control;
in the event that the potential customer interacts with the customer-ID submit control, electronically transmitting to the selected commercial outlet an indication of customer-ID; and
in the event that the potential customer presents the indication of customer-ID at the selected commercial outlet, providing the potential customer with the offered discount.
